(19) United States
(12) Patent Application Publication
(10) Pub. No.: US 2012/0116904 A1
(43) Pub. Date: May 10, 2012

(54) METHOD AND SYSTEM FOR PAYING TAXES

(76) Inventor: Nick Arakelian, La Canada, CA (US)

(21) Appl. No.: 12/943,664

(22) Filed: Nov. 10, 2010

(51) Int. Cl. G06Q 40/00; G06Q 30/00

(52) U.S. Cl. 705/19; 705/31

(57) ABSTRACT

A method and system for efficiently managing and submitting taxes by placing taxes that are collected from sales into separate, verifiable, one or more virtual banks accounts, before submitting the owed taxes to the appropriate government agencies. The user can specify the frequency of tax submission, such as weekly or monthly. The software system can distinguish taxable sales from non-taxable sales for sales tax, as well as apply other types of taxes, including use taxes, luxury taxes, value added taxes, fuel taxes, tobacco taxes, alcohol taxes, and the like. The software system can also be configured to set aside the required payroll taxes and garnishments for each employee based on entered input, such as hourly wages, number of hours worked, etc. After setting aside the payroll taxes into one or more virtual accounts, the taxes are sent to the appropriate government agencies.

### FIELD OF THE INVENTION

The teachings herein are directed to a retail point of sale software system that recognizes and separates revenue from sales and services that are taxable from non taxable goods and services, and then automatically sends the tax due to the appropriate tax collecting agencies and methods of performing the same.

### BACKGROUND

The responsibilities of collecting and reporting taxes, such as sales taxes, payroll taxes, alcohol taxes, fuel taxes, etc. are a necessary component of running a small business. The correct amount of tax earned on all transactions passing through the business, including both products and services, must be transferred to the appropriate tax-collecting government agency in a timely manner. Current methods require complicated accounting and business planning to ensure adequate funds exist to pay the various taxes owed to the government. Accordingly, there is a growing need for a point of sale software system that aids business entities in managing the amount of taxes owed.

Current practice for reporting sales tax typically require business entities to gather all sales for a certain time period, determine which sales of products or services are taxable, and then calculate the taxable amount of sales using the appropriate tax rates. Once the amount of tax is calculated for a certain time period, usually monthly or quarterly, the business entity must pay the tax amounts to the appropriate government agency (e.g., California Franchise Tax Board, etc). However, the taxes owed are often not accounted for or calculated until just prior to the required submission. As a result, these funds can be commingled with operating income and can mistakenly be used for other purposes, such as to finance everyday operations of the business or to purchase merchandise. If proper accounting is not maintained, or sales of the company are less than expected, it is possible that a company will divert funds that should be designated for paying the government for taxes, and as a result, the business will be unable to pay the full amount of taxes owed in the timely manner. Consequently, creating unnecessary fees, penalties and interest for the business entity. Furthermore, if this vicious cycle repeats the next period, and the next, the amount to the government agency may become insurmountable for the business to cure. To respond to this country-wide epidemic, the respective government agencies have to spend funds they did not anticipate spending on hiring new personnel and or collection agencies, imposing costly liens and levies on the business entities to recover the funds owed. Most importantly, the respective government agencies will have consistent cash flow and will no longer have spent valuable resources on collection services. Moreover, businesses will not face painful law suits, levies and penalties and interest in addition to their past due balances.

Current payroll systems calculate the appropriate tax amounts for each employee, but the employer still must separate the different taxes manually (e.g. FICA, FUTA, etc) and send the taxes to their respective government agencies. A more convenient system for computing payroll taxes and automatically submitting the taxes to the appropriate government agency is desired, thus saving the business entity labor, time, and money.

An automated point of sale software system requires a business entity to account for owed taxes on a frequent basis, and thus is advantageous to both the business and the government. A business entity can ensure that penalties are avoided for late or insufficient payments. The business entity will have up-to-date account balances and will not use funds that are owed to the government. In addition, the government will enjoy a steady flow of revenue from businesses for appropriate sales taxes and employee taxes. The discretion is taken out of the business entity and thus the government will collect the owed taxes. The system software will reduce human error, cost of paper and postage, and likelihood of losing checks in the mail. As more and more businesses are unable to make payments on sales and payroll taxes, the government has to withstand the burden of insufficient payments. Incidentally, the consumer pays the sales tax or VAT at the time of purchase to the business. These funds commingle with other revenue from the business and are at the sole discretion of the business entity or accounting firm to calculate and forward to the respective government agencies. State and federal income taxes have already been deducted from employee checks by the business entity at the end of each pay period, again these funds are at the discretion of the business entity to forward to the respective government agencies.

Accordingly, it is the object of the teachings herein to provide a retail point of sale software system and method of separating and placing the taxable funds, apart from other income, into a virtual account, and subsequently sending the owed taxes automatically to the appropriate government agencies, ensuring that all owed taxes are transferred in a timely manner. This innovation intends to alleviate potential shortcomings of (but not limited to) sales tax, VAT, and payroll tax, by re-routing the collected funds or deducted funds, to a holding account and ultimately to the respective government agencies. The business entity will not be able to use these funds, which do not belong to them, to operate the business. Ultimately, the businesses will be healthier because they will not have the burden of past due taxes with penalties and interest, and the government agencies will have steadier cash flow and less resources will have to be allocated for collection efforts.

### SUMMARY OF THE INVENTION

Embodiments herein are directed to retail point of sale software systems comprising: a software application, running on a hardware device, that performs: (a) an analysis of the type of products or services rendered (b) a determination of whether a tax should be applied to the sale of products or services rendered (c) a calculation of the amount of owed taxes using current tax rates (d) a segregation between owed taxes and other funds(e) a deposit of owed taxes into one or more virtual bank accounts and(e) an automatic submission of the owed taxes held in one or more virtual bank accounts to the appropriate government agency.

Further embodiments are directed to methods of managing taxes by a software application, running on a hardware device, comprising: (a) analyzing the type of products or services rendered (b) determining whether a tax should be applied to the sale of products or services rendered (c) calculating the amount of owed taxes using current tax rates (d) segregating the owed taxes into one or more virtual bank accounts and (e) automatically submitting the owed taxes held in said one or more virtual bank accounts to the appropriate government agency.

### BRIEF DESCRIPTION OF THE DRAWINGS

FIG. 1 is a block diagram showing the general components of the system.

FIG. 2 is a flow diagram showing the system automating sales tax payments.

FIG. 3 is a flow diagram showing the system automating payroll tax payments.

FIG. 4 is a flow diagram showing the system automating payroll tax payments with a garnishment option.

FIG. 5 is a flow diagram showing the system automating payroll tax payments with a tax verification step.

### DETAILED DESCRIPTION OF THE ILLUSTRATED EMBODIMENTS

Embodiments of the present invention are described below. It is, however, expressly noted that the present invention is not limited to these embodiments, but rather the intention is that modifications that are apparent to the person skilled in the art and equivalents thereof are also included.

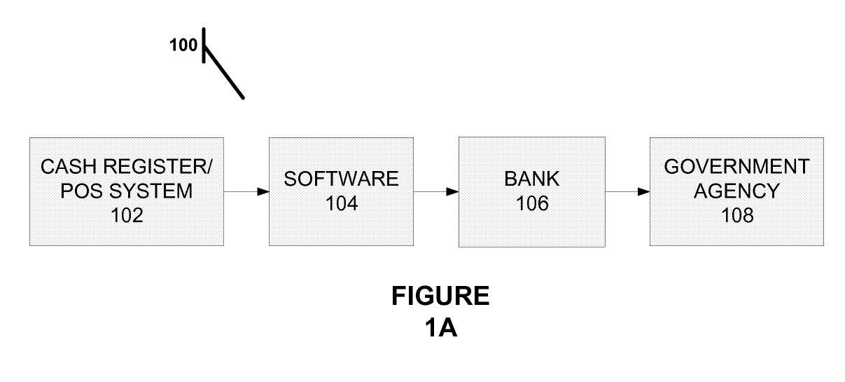

The teachings herein are directed to a novel, retail point of sale software system. FIG. 1 is a block diagram 100 showing the general components of the point of sale system. In preferred embodiments, the user will utilize a computerized cash register 102 to account for each good or service provided to the customer. The user can include the business entity, a manager, or any employee authorized to use the computerized cash register 102. The computerized cash register 102 is incorporated into or otherwise linked to a computing hardware system, allowing the information regarding the specific good or service rendered to be sent and analyzed by the complete point of sale software 104. The software 104 determines whether the goods or services are taxable or non-taxable, and if sales, use, fuel, alcohol, or tobacco taxes apply. If a specific tax is applicable, the software 104 will compute the amount of tax using up-to-date tax information for the county of the state where the business resides. Annual updates can be made available to ensure the software 104 uses the most recent tax rates.

In various embodiments, the complete software 104 runs on a computing hardware system, without the aid of a computerized cash register 102. In alternative embodiments of the system, the software 104 is a plug-in software application compatible with other tax calculating software and/or reporting software for a computing hardware system, rather than a complete software package. Embodiments of the current invention running on a computer hardware system are most ideal for e-commerce, where no actual cash register 102 is used. In addition, many ‘Mom-and-Pop’ businesses, or family run businesses, do not use an expensive computerized cash register 102. In a situation where a mechanical cash register with no modem is used, the software 104 can be integrated with the bank account information, where payroll taxes will be automatically separated at the bank account level. The user may have to enter additional inputs, such as what is taxable and non-taxable, for collecting sales tax using a non-computerized cash register. The software 104 running on a computing hardware system can allow easy computation of payroll taxes, social security, FICA, etc., as a computing hardware system will allow the user to easily input the necessary employee information, such as employee identification number, hourly wage, number of hours worked, etc.

The various taxes that are computed by the software 104 are deposited into one or more virtual accounts 106. A virtual account 106 is an actual, separate bank account that exists apart from the regular bank account of the business. The virtual account 106 serves as an intermediary between the business account and the local, state, and federal government agencies that collect taxes, and is configured to hold and transmit owed taxes to said agencies. A virtual account 106 ensures that there is no direct line of communication between business accounts and government agencies as most business entities would want to prevent direct access to their operating account. In various embodiments, a separate virtual account 106 can exist for each specific type of tax, e.g., sales tax, alcohol tax, FICA SS, etc. In alternative embodiments, a separate virtual account 106 exists for each different government entity where the taxes must be sent. In this embodiment, a virtual account 106 can include both sales and alcohol taxes, if both taxes must be sent to the same government agency. For example, in the state of California, sales, fuel, and alcohol taxes are all sent to the California State Board of Equalization. Thus, a virtual account 106 can exist for all taxes that must be sent to the California State Board of Equalization, regardless if the same virtual account 106 contains various types of taxes.

Once the tax amounts are deposited into one or more virtual accounts 106, the software 104 recognizes the appropriate government agencies 108 where the taxes must be submitted to. For example, if the business resides in the state of California, the software 104 will be configured to send all sales and use, fuel, alcohol, and tobacco taxes to the California State Board of Equalization. Likewise, if a business entity residing in California wishes to transfer payroll taxes, the funds will transfer to the Employment Development Department (EDD). The business entity can predetermine and set the frequency of automatic transfers, such as monthly or quarterly based on their reporting duties. In preferred embodiments, an Easy Accounting System will allow the business entity to self-audit and verify the funds in each virtual account 106, before the funds are transferred. Each virtual account 106 can be identified by the business entity's Federal Tax ID Number or Social Security Number, so each government agency 108 can easily match the received funds with the correct business. In addition, the business entity can specify the method of transfer to the government agency 108 (e.g., Automatic Clearing House or wire), thus enabling the entity to choose the most cost-effective method.

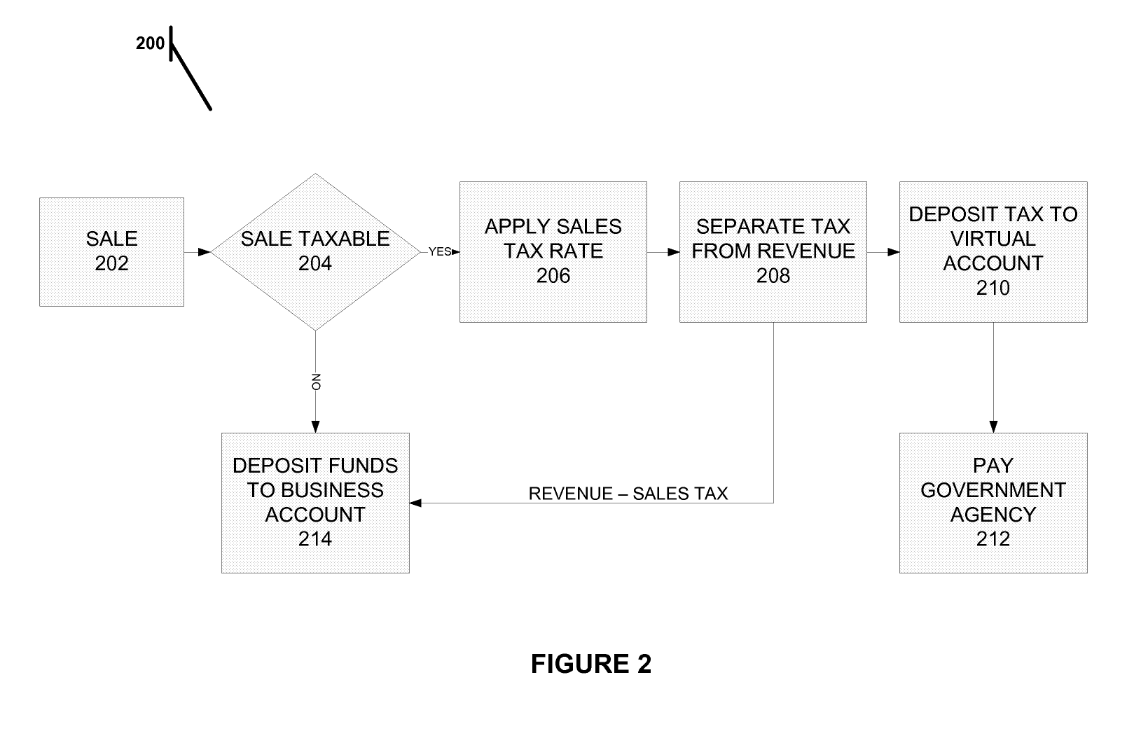

FIG. 2 is a flow diagram 200 showing the retail point of sale software system separating and automating tax payments. The system software is configured to recognize different types of sales 202, such as taxable and non-taxable sales, and determines which sales are taxable and non-taxable 204. The software utilizes current state laws governing which sale of products and services are taxable or non-taxable. This information can be programmed into the software or inputted into the system by the user. Once a sale 202 is determined to be taxable, the appropriate tax rate 206 is applied. The software then separates the tax from the income 208, where the tax is deposited into one or more virtual accounts 210, and the income is deposited to a separate business account 214. The taxes in the virtual account(s) can be configured to be automatically paid to the appropriate government agencies 212, ensuring that all owed taxes are transferred in a timely manner.

In various embodiments, the software system will recognize a sales tax on certain products or services. A sales tax is a consumption tax charged at the point of purchase for certain goods and services, depending on state law. For example, tax-exempt products in many states include prescription medication and unprepared groceries. While services are generally exempt from sales taxes, some states require sales tax to be collected for certain services. For example, providing computer services in the state of Texas is a sales-taxable service. The merchant has the responsibility to collect the sales tax at the time of sale, and then remand the sales taxes to the state. The sales taxes that are collected from sales 202 involving taxable goods are calculated at the appropriate tax rate 206. The sales taxes are logged and separated from the income 208, and the sales taxes are deposited into a virtual account 210. The sales taxes in the virtual account 210 are automatically paid to the appropriate government agency 212.

In various embodiments, the software system will recognize a use tax on certain products. A use tax can be collected for certain goods and services, when a sales tax has not been charged. Generally, the use tax rate is the same as the sales tax rate. The most common transactions subject to a use tax are purchases made over the internet and out-of-state. The use taxes that are collected from sales 202 involving taxable goods are calculated at the appropriate tax rate 206. The use taxes are logged and separated from the income 208, and the use taxes are deposited into a virtual account 210. The use taxes in the virtual account 210 are automatically paid to the appropriate government agency 212.

In various embodiments, the software system will recognize, but is not limited to, fuel, alcohol, and tobacco taxes. The fuel, alcohol, and tobacco taxes that are collected from sales 202 involving taxable goods are calculated at the appropriate tax rate 206. The fuel, alcohol, and tobacco taxes are logged and separated from the income 208, and the taxes are deposited into a virtual account 210. The fuel, alcohol, and tobacco taxes in the virtual account are 210 automatically paid to the appropriate government agency 212.

In various embodiments, the software system will recognize a value added tax on certain products. A value added tax is a tax on the estimated market value added to a product or material at each stage of its manufacture or distribution, which are ultimately paid by the consumer. The value added taxes that are collected from sales 202 involving taxable goods are calculated at the appropriate tax rate 206. The value added taxes are logged and separated from the income 208, and the value added taxes are deposited into a virtual account 210. The value added taxes in the virtual account 210 are automatically paid to the appropriate government agency 212.

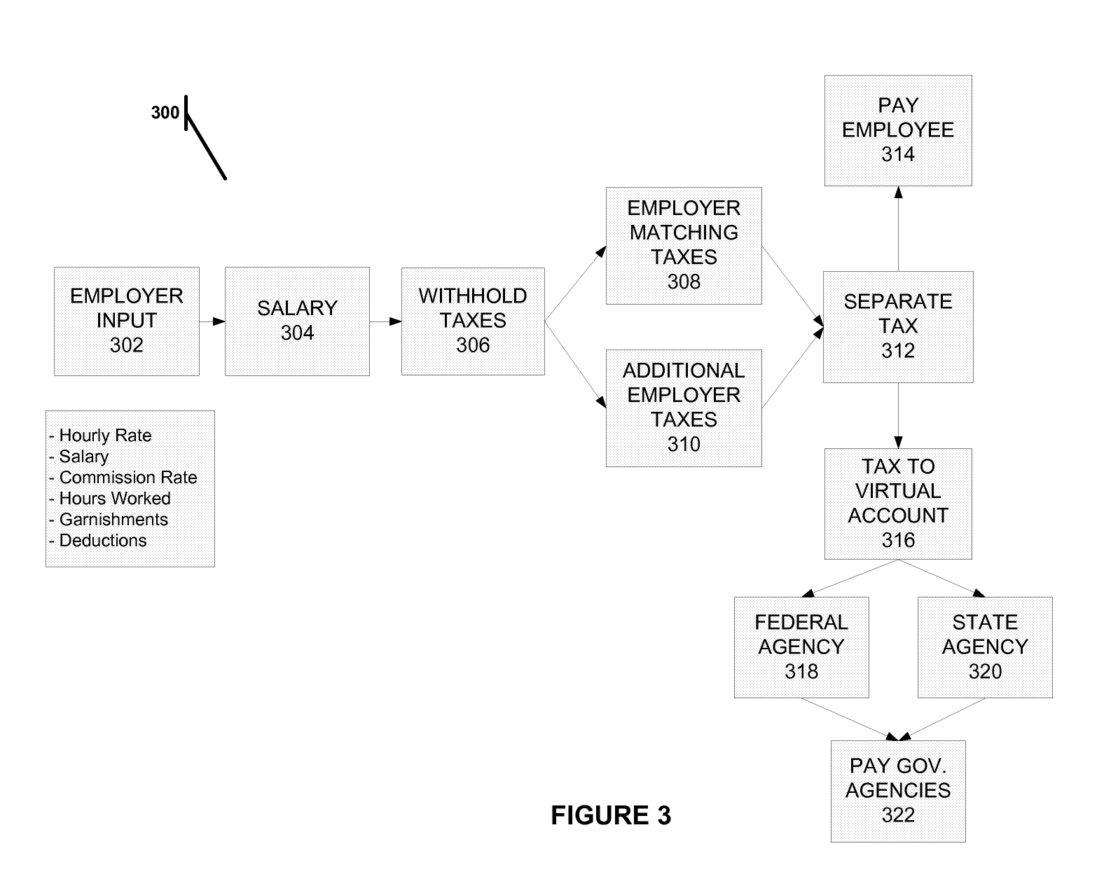

FIG. 3 is a flow diagram 300 showing the software system automating payroll tax payments to the appropriate government agencies. The employer must enter necessary one-time input 302 for each employee, such as name, address, social security number, number of exemptions, etc. Employee biographical information will be stored onto the system. In addition, input 302 regarding hourly wage or salaried income, the number of hours worked in a given week, etc. must be entered on a periodic basis by the business entity or manager. The business entity or manager can enter input 302 specifying the frequency of pay periods (e.g., weekly, bimonthly, or monthly). Suppose an employee's salary increases or withholdings are changed, the business entity or manager can easily update the employee information by simply entering new input 302. Similarly, if an employee calls in sick, the business entity can adjust the employee's hours. In various embodiments, the hours worked per employee is integrated with the pay scheduling (calendar) software, as a convenient method of tracking, on a given day, the specific employee on duty and how many hours were worked.

Once all necessary input 302 is entered into the system, the software 104 computes the total salary 304 earned for a specific pay period by an employee. If overtime is worked, for example more than forty hours per week, the software 104 automatically adjusts the hourly rate before calculating the salary earned 304. However, before the employee can receive a paycheck of the computed salary 304, the software 104 must calculate all the necessary state and federal taxes that must be withheld. The software automatically withholds a certain percentage of state and federal taxes 306. Employers are required to withhold a portion of each employee's income and pay it directly to the Internal Revenue Service (IRS) and state agency. The software 104 will calculate the percentage withheld based on the input 302 entered for each employee.

Based on the amount that equals the earned salary 304 minus the state and federal taxes 306 that are withheld, the employer must contribute employer matching taxes 308 and additional employer taxes 310. The software 104 will compute the employer matching taxes 308 and additional employer taxes 310 using the salary information 304 and current tax rates for the state where business operations reside. Common employer matching taxes 308 include the Federal Insurance Contributions Act Social Security (FICA SS) and Federal Insurance Contributions Act Medicare (FICA MED). Additional employer taxes 310 can include the Federal Unemployment Tax Act (FUTA), as well as State Unemployment Tax Act (SUTA).

Once the system software 104 calculates the withheld state and federal taxes 306, the employer matching taxes 308, and any additional employer taxes 310, the funds are separated into tax and employee income components 312. The business entity pays the employee 314 after all necessary taxes are withheld and taken out. The tax component is deposited into virtual accounts 316. The tax component is composed of the withheld state and federal taxes 306, the employer matching taxes 308, and additional employer taxes 310. In preferred embodiments, the virtual accounts 316 will be separated into two separate virtual accounts: one will store the taxes needing to be sent to a federal agency 318, while the other virtual account stores the taxes needing to be sent to a state agency 320. For example, the taxes held for FIFA SS, FIFA MED, FUTA, and withheld federal taxes can all be stored in a single virtual account, as all the taxes must be sent to the same federal agency (IRS). The taxes held for SUTA and withheld state taxes can be stored in a separate virtual account, as both types of taxes must be sent to the same state agency, such as the EDD if the business resides in California. The payroll taxes residing in the virtual account for federal agencies 318 can be configured to be automatically sent to the appropriate federal government agencies 322. Similarly, the payroll taxes residing in the virtual account for the state agencies 320 can be configured to be automatically sent to the appropriate state government agencies 322.

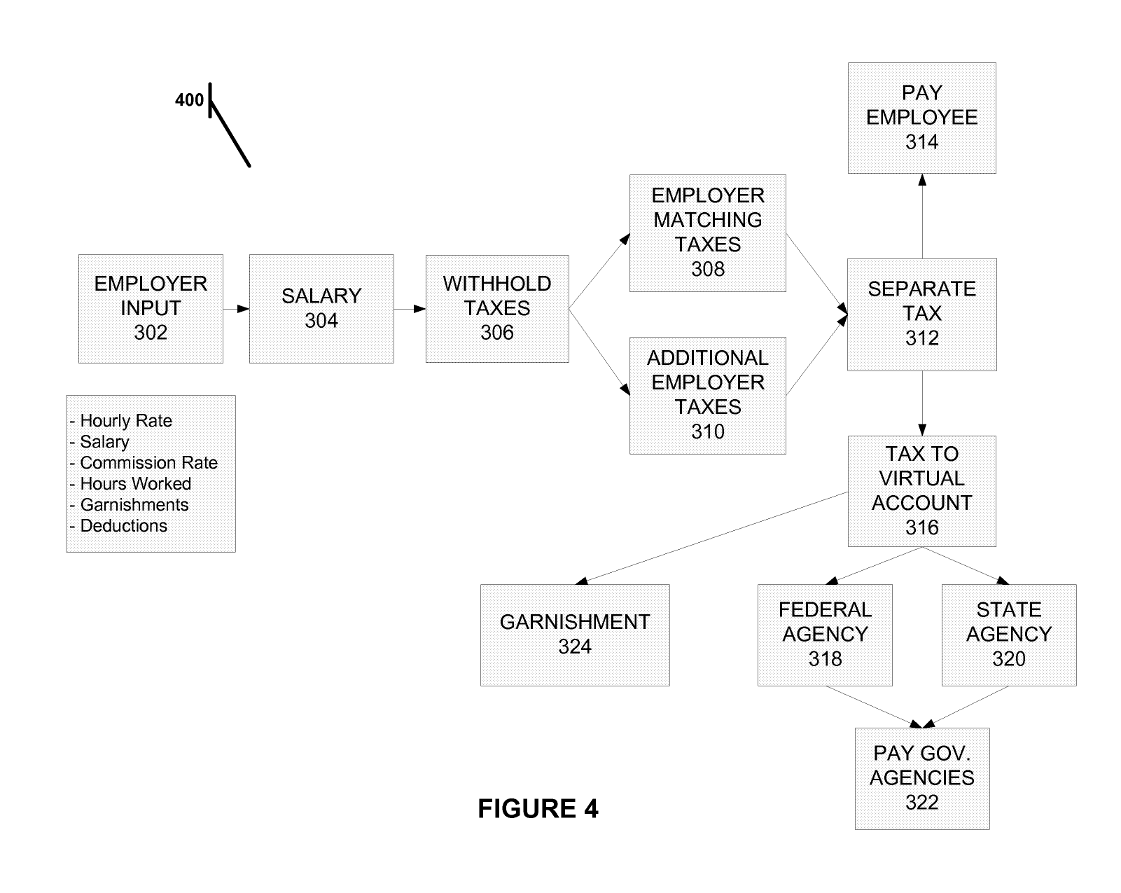

In various embodiments, and as shown in the flowchart 400 shown in FIG. 4, a certain percentage of employee income can be separated into a virtual account as a result of a wage garnishment, which is the process of deducting money from an employee's monetary compensation, usually until a certain debt is paid off. The business entity can enter input 302 specifying the amount of the wage deduction. Wage garnishments are commonly used to pay off debts, such as credit card, child support, or alimony. The software system can deposit the garnishment into a virtual account 318, which in step 324 is sent to the appropriate entity designated by the terms of the garnishment, whether governmental or private.

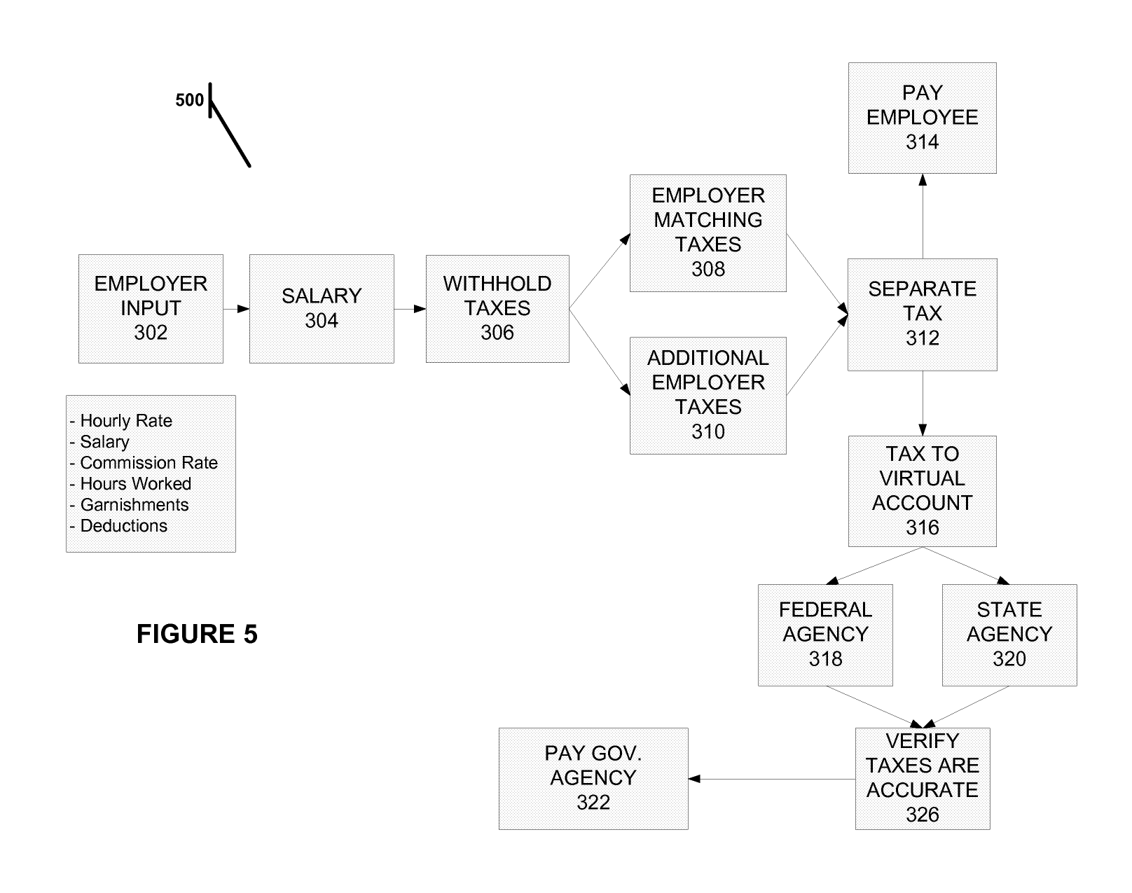

In preferred embodiments, and as shown in the system 500 shown in FIG. 5, a self-audit system can allow the business entity to verify the funds in each of the virtual accounts 316, before submitting the taxes to the appropriate government agencies. In step 326, the funds in each virtual account can be monitored daily, weekly, or as often as required by the business entity. In various embodiments, the payroll information in the federal virtual account 318 and state virtual account 320 can be sent to an independent payroll company (such as ADP) or company accounting firm or bookkeeper for verification for verification by the business entity. They will enter the account via their TIN (taxpayer's identification number, which every business has), and a PIN number. Once the payroll tax sends a confirmation that the payroll taxes were calculated correctly, the business entity can send the taxes to the appropriate agency. In alternative embodiments, the taxes in virtual accounts 318 and 320 will be sent to the appropriate government agencies 322, while a summary of the taxes paid will simultaneously be sent to ADP or company accounting firm/bookkeeper. Once receiving the report,

ADP or company accounting firm/bookkeeper can either verify the correct amount of taxes were paid, an insufficient amount of taxes were paid, or an excess amount of taxes were paid.

### EXAMPLES

### Example 1

This Example shows how the teachings herein can be used to recognize taxable sales, apply the applicable tax rate, and distribute taxes to the appropriate government agency. A customer spends $500 on a watch repair service, not subject to a sales tax, and $500 on a brand new watch which is subject to a sales tax at a 10% sales tax rate. The software system recognizes the watch repair service as non-taxable, but that a 10% sales tax applies to the watch sale. In addition, the software system recognizes that a total amount of $1050 is collected for this transaction. The $1050 total results from adding the $500 watch repair service, the $500 for the sale of the watch, and the $50 sales tax (10% of $500) collected on the watch. The software segregates $1000 into a regular bank account and $50into the sales tax virtual account. Depending on the set frequency of submission (i.e. weekly, bi-weekly, or monthly) the sales taxes are quickly submitted to the appropriate government agency, such as the California State Board of Equalization for this example.

### Example 2

This Example shows how the teachings herein can be used by an employer to pay state and federal payroll taxes. An employee works in California and earns $10 an hour, while working 36 hours for a given week. The software system calculates that $360 is earned by the employee for the week. The software applies the current federal and state tax rates, and calculates that the total federal taxes withheld equal $66.44 and the total state taxes withheld equal $8.36. Thus, the net pay of the employee equals $285.20. The software also sets aside the necessary amount of employer matching taxes and additional employer taxes. In this example the employer is responsible for matching both FICA SS and FICA MED, which equals $27.54. Additional employer taxes are paid for both federal and state unemployment taxes (FUTA and CA SUTA), where FUTA equals $2.88 and CA SUTA equals $8.64. The software recognizes that for this single employee, the following payroll taxes must be paid to the appropriate agencies: federal taxes withheld, state taxes withheld, FICA SS, FICA MED, FUTA, and CA SUTA. The business entity sets the software to create a virtual account for each government agency where the taxes need to be sent. Federal taxes that are withheld, FICA SS, FICA MED, and FUTA all are sent to the Internal Revenue Service. Thus, a virtual account containing $66.44 for federal taxes withheld, $27.54 for FICA SS and FICA MED, and $2.88 for FUTA sends this money to the IRS. State taxes that are withheld and CA SUTA all are sent to the Employment Development Department (EDD). Thus, a separate virtual account containing $8.36 for state taxes withheld and $8.64 for CA SUTA are sent to the EDD.

The sales tax 200 and payroll tax 300 systems can be on separate or integrated software for the embodiments described herein. The invention may be embodied in other specific forms besides and beyond those described herein. The foregoing embodiments are therefore to be considered in all respects illustrative rather than limiting, and the scope of the invention is defined and limited only by the appended claims and their equivalents, rather than by the foregoing description.

What is claimed is:

1. A retail point of sale software system comprising:
a software application, running on a hardware device, that performs:
(a) an analysis of the type of products or services rendered;
(b) a determination of whether a tax should be applied to the sale of products or services rendered;
(c) a calculation of the amount of owed taxes using current tax rates;
(d) a segregation between owed taxes and other funds;
(e) a deposit of owed taxes into one or more virtual bank accounts; and
(e) an automatic submission of the owed taxes held in one or more virtual bank accounts to the appropriate government agency.

2. The software system of claim 1, wherein said owed taxes comprise sales and use taxes, luxury taxes, value added taxes, fuel taxes, alcohol taxes, and tobacco taxes.

3. The software system of claim 1, wherein the software application further manages payroll taxes by performing:
(a) a computation of an employee's salary for a given pay period, based on employer input entered and stored onto the software system;
(b) a computation of federal and state taxes that are withheld based on current tax rates;
(c) a computation of employer's matching taxes and additional employer taxes;
(d) depositing said federal, state and employer's taxes into one or more virtual bank accounts; and
(e) automatically transmitting the taxes held in the one or more virtual bank accounts to the appropriate government agency.

4. The software system of claim 3, wherein said hardware device is a computerized cash register.

5. The software system of claim 3, further comprising one or more separate business bank accounts that hold funds that are not owed tax.

6. The software system of claim 3, further comprising a self-audit software application for verification that the correct funds are in said one or more virtual bank accounts before the software application automatically submits the owed taxes to the appropriate government agency.

7. The software system of claim 3, wherein said system comprises a separate virtual bank account for each government agency to be paid.

8. The software system of claim 3, wherein said system comprises a separate virtual bank account for each type of said owed tax.

9. The software system of claim 3, further comprising verification by an external payroll company before said payroll taxes are submitted to said appropriate government agency.

10. A method of managing taxes by a software application, running on a hardware device, comprising:
(a) analyzing the type of products or services rendered;
(b) determining whether a tax should be applied to the sale of products or services rendered;
(c) calculating the amount of owed taxes using current tax rates;
(d) segregating the owed taxes into one or more virtual bank accounts; and
(e) automatically submitting the owed taxes held in said one or more virtual bank accounts to the appropriate government agency.

11. The method of claim 10, wherein said owed taxes comprise sales and use taxes, luxury taxes, value added taxes, fuel taxes, alcohol taxes, and tobacco taxes.

12. The method of claim 11, further comprising:
(a)computing an employee's salary for a given pay period, based on employer input entered and stored onto the software application;
(b) computing federal and state taxes that are withheld based on current tax rates;
(c) computing the employer's matching taxes and additional employer's taxes;
(d) depositing the federal, state, and employer's taxes into one or more virtual bank accounts; and
(e) automatically transmitting the taxes held in the one or more virtual bank accounts to the appropriate government agency.

13. The method of claim 12, wherein said hardware device is a computerized cash register.

14. The method of claim 12, further comprising depositing non tax funds into one or more separate business bank accounts.

15. The method of claim 12, further comprising verifying that the correct funds are in said one or more virtual bank accounts before automatically submitting the owed taxes to the appropriate government agency.

16. The method of claim 12, wherein the taxes are deposited into a separate virtual bank account for each government agency to be paid.

17. The method of claim 12, wherein the taxes are deposited into a separate virtual bank account for each type of owed tax.

18. The method of claim 12, further comprising verification by an external payroll company before said federal, state, and employer's taxes are automatically transmitted to the appropriate government agency.
